(19) United States
(12) Patent Application Publication
(10) Pub. No.: US 2026/0235477 A1
(43) Pub. Date: Aug. 13, 2026

(54) METHOD AND SYSTEMS FOR MATERIAL EXTRACTION

(71) Applicants: PURDUE RESEARCH FOUNDATION, West Lafayette, IN (US); ADVANCED MEDICINE PARTNERS, LLC, Lake Forest, IL (US)

(72) Inventors: David John CAPPELLERI, West Lafayette, IN (US); Max BECKEMEIER, 101 Foundry Drive, IL (US); Aayush MATHUR, West Lafayette, IN (US); Jared HORTON, West Lafayette, IN (US); Andrew KNUDTEN, Lake Forest, IL (US); Benjamin KREMKOW, Lake Forest, IL (US); Phillip WAGNER, Lake Forest, IL (US); Zach STANLEY, Lake Forest, IL (US)

(21) Appl. No.: 19/153,476

(22) PCT Filed: Feb. 8, 2024
(86) PCT No.: PCT/US2024/015033

§ 371 Date: Aug. 4, 2025

Related U.S. Application Data
(60) Provisional application No. 63/483,922, filed on Feb. 8, 2023.

(51) Int. Cl. G01N 1/14

(52) U.S. Cl. CPC G01N 1/14

(57) ABSTRACT

The disclosure describes systems and methods for material extraction from a container. The system may include a base plate. The base plate may include a sensor having a field of view. The system may include a support. The support may be configured to receive a container that includes a density gradient with material stratified into a band. The system may include a first actuator. The first actuator may be configured to move the support and container with respect to the field of view and with respect to the base plate. The system may include an extraction assembly. The extraction assembly may be coupled to the base plate. The extraction assembly may include a needle. The needle may move with respect to the base plate and may engage the container.

### CROSS REFERENCE TO RELATED PATENT APPLICATION

This application claims priority to, and the benefit of, U.S. Provisional Patent Application No. 63/483,922 filed Feb. 8, 2023, the entire contents of which are hereby incorporated herein by reference for all purposes.

### BACKGROUND

Centrifuges can be used to separate materials. For example, molecules, deoxyribonucleic acid (DNA), ribonucleic acid (RNA), and viral particles, such as bacteriophage and parvoviruses (such as adeno associated virus or AAV), and other materials may be dispersed in a solution. These materials may be separated through centrifugation or ultracentrifugation to form a density gradient throughout the container. Once bands of material pertaining to specific densities are formed that include the material of interest, extraction may be needed without disturbing the sensitive materials therein. Automated methods of harvesting the material of interest separated by ultracentrifugation on a density gradient would facilitate scale of purification methods and would fill a need in the art.

### SUMMARY

It is to be understood that both the following general description and the following detailed description are illustrative and explanatory only and not restrictive.

In one embodiment, the disclosure describes a system. The system may include a base plate. The base plate may include a sensor having a field of view. The system may include a support. The support may be configured to receive a container that includes a density gradient with material stratified into a band. The system may include a first actuator. The first actuator may be configured to move the support and container with respect to the field of view and with respect to the base plate. The system may include an extraction assembly. The extraction assembly may be coupled to the base plate. The extraction assembly may include a needle. The needle may move with respect to the base plate and may engage the container.

In another embodiment, the disclosure provides an apparatus. The apparatus may include a slide rail member. The apparatus may include a needle housing. The needle housing may be disposed above the slide rail member. The needle housing may be configured to move along the slide rail member. The apparatus may include a needle coupled to the needle housing.

In another embodiment, the disclosure provides a method for extracting material. The method may include moving a container comprising material about a field of view of a sensor. The method may include determining a range indicative of a portion of the material. The range may be based on the sensor. The method may include moving the material. The material may be moved based on the range. The method may include moving a needle in a direction of travel to insert a tip of the needle through the container. The method may include extracting the portion of the material.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

In order to provide an understanding for the techniques described, the figures provide non-limiting examples in accordance with one or more implementations of the present disclosure, in which:

FIG. 1 illustrates an example system for material extraction in accordance with one example embodiment of the disclosure;

FIG. 2 illustrates an example extraction assembly in accordance with one example embodiment of the disclosure;

FIG. 3 illustrates an example container in accordance with one example embodiment of the disclosure;

FIG. 4 shows an example system for material extraction in accordance with one example embodiment of the disclosure;

FIG. 5 illustrates an example extraction assembly in accordance with one example embodiment of the disclosure;

FIG. 6 illustrates example values derived from scanning of the pixel values over the length of the ultracentrifuge tube in accordance with one example embodiment of the disclosure;

FIG. 7 illustrates an example computing system of the material extraction system in accordance with one example embodiment of the disclosure; and

FIG. 8 illustrates a flowchart of an example method for material extraction in accordance with one example embodiment of the disclosure.

### DETAILED DESCRIPTION

As used in the specification and the appended claims, the singular forms “a,” “an,” and “the” include plural referents unless the context clearly dictates otherwise.

Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memristor, Non-Volatile Random Access Memory (NVRAM), flash memory, or a combination thereof.

This detailed description may refer to a given entity performing some action. It should be understood that this language may in some cases mean that a system (e.g., a computer) owned and/or controlled by the given entity is actually performing the action.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a special purpose computer or other programmable data processing instrument to produce a machine, such that the processor-executable instructions which execute on the computer or other programmable data processing instrument create a device for implementing the steps specified in the flowchart block or blocks.

These processor-executable instructions may also be stored in a non-transitory computer-readable memory or a computer-readable medium that may direct a computer, controller, or other programmable data processing instrument to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing instrument to cause a series of operational steps to be performed on the computer, controller, or other programmable instrument to produce a computer-implemented process such that the processor-executable instructions that execute on the computer or other programmable instrument provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

A centrifuge or ultracentrifuge may be used to purify or isolate materials on a density gradient during, after or in connection with production workflows. For example, particles, including viral particles, such as, but not limited to, AAV particles and other matter may be purified away from contaminants of different densities by ultracentrifugation of the material on a density gradient (for example, but not limited to, a cesium chloride (CsCl) gradient, such as a 3M CsCl density gradient) during manufacture. The centrifuge may be used to stratify the solution into a density gradient. After stratification, material of interest may be identified in one or more bands in the ultracentrifuge tube and extracted for further processing. Disclosed herein are methods and systems for harvesting of one or more bands of material from the density gradient within the ultracentrifuge tube.

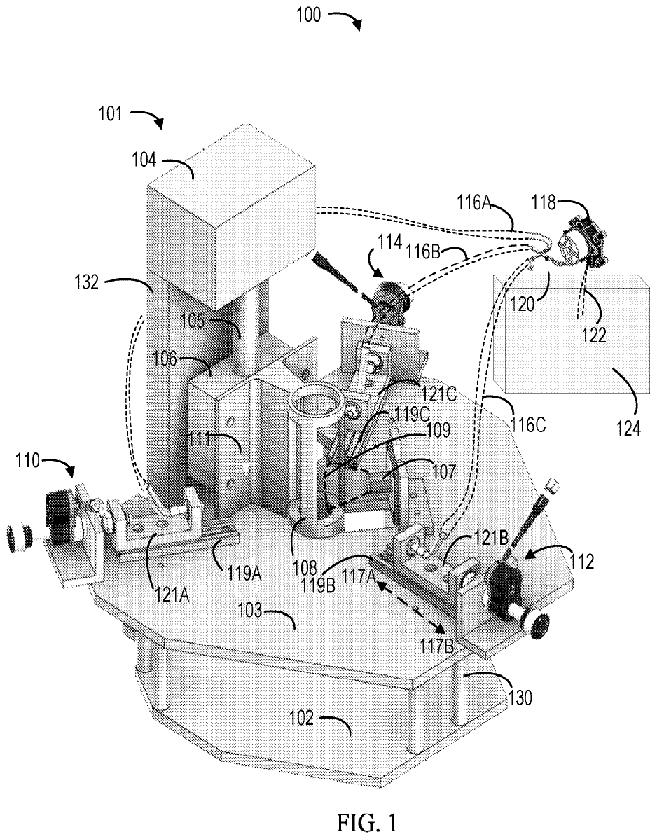

FIG. 1 shows an example system 100 for material extraction according to one example embodiment. Referring to FIG. 1, the example system 100 may include a chassis or material extraction platform 101 (hereinafter “chassis 101”). The chassis 101 may include a lower base plate 102, an upper base plate 103, and one or more plate supports 130 extending from the lower base plate 102 to the upper base plate 103. In certain examples, the lower base plate 102 and the one or more plate supports 130 may be optionally removed. The lower base plate 102 may include a top surface and an opposing bottom surface. For example, the bottom surface of the lower base plate 102 may be planar or substantially planar or flat, to provide a surface for resting the system 100 on the material extraction system on a floor or other surface. The upper base plate 103 may include a top surface and an opposing bottom surface. The bottom surface of the upper base plate may face the top surface of the lower base plate 102. For example, the upper base plate 103 may be parallel or substantially parallel with the lower base plate 102, such that a plane defined by the upper base plate 103 is parallel with a plane defined by the lower base plate 102. For example, the upper base plate 103 may be a planar or substantially planar or flat top surface. For example, the one or more plate supports 130 may comprise a plurality of plate supports 130. The one or more plate supports 130 may extend vertically or substantially vertically from a top surface of the lower base plate 102 to a bottom surface of the upper base plate 103. For example, the one or more plate supports 130 may be positioned along a perimeter of the lower base plate 102 and/or upper base plate 103. For example, the upper base plate 103 and the lower base plate 102 may be constructed of metal, plastic, wood, composite, or any combination thereof.

The chassis 101 may define planes of translation for components of the system 100 and references for those components. The chassis 101 may include a vertical slide panel 106. The vertical slide panel 106 may be configured to move vertically about an axis or plane defined by a vertical slide rail 105. For example, the vertical slide rail 105 may extend through an aperture defining a passageway through at least a portion of the vertical slide panel 106. For example, the vertical slide rail 105 may be a fixed rail. While the example of FIG. 1 shows the vertical slide rail 105 as being a single fixed rail, in other examples, two or more rails may comprise the vertical slide rail 105. The vertical slide rail 105 may be column-shaped and extend vertically or substantially vertically above the top surface of the upper base plate 103. For example, the vertical slide rail 105 or a support panel 132 coupled directly or indirectly to the vertical slide rail 105 may be coupled to one or more of the lower base plate 102 or the upper base plate 103. The vertical slide panel 106 may be configured to move vertically along the vertical slide rail 105. For example, the vertical slide panel 106 may be actuated by a motor 104 to move the vertical slide panel 106 vertically up and down along the vertical slide rail 105. For example, the motor 104 may be a stepper motor or any other type of motor. For example, the motor 104 may include sensory feedback. For example, the motor 104 may be communicably coupled to one or more sensors, such as an optical sensor or proximity sensor, to accurately manage the position of the vertical slide panel 106, such as in steps. In certain example embodiments, the motor 104 may be replaced with another device coupled to the vertical slide panel 106, such as a hydraulic or pneumatic actuator, for vertically adjusting the position of the vertical slide panel 106. For example, each of the steps implemented by the motor 104 to move the vertical slide panel 106 may be equivalent over the range of motion of the vertical slide panel 106 and defined according to a metric (e.g., inches, millimeters). For example, each step may be 1 millimeter.

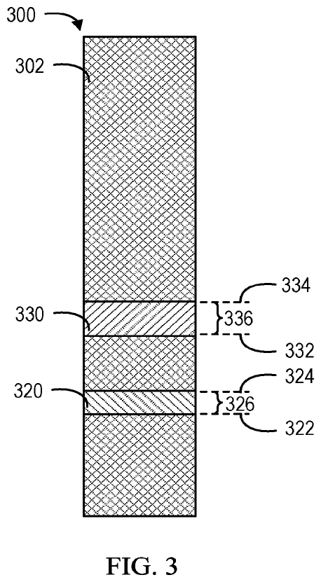

The chassis 101 may include a container support panel 111. For example, the container support panel 111 may be coupled to the vertical slide panel 106 and may be configured to move vertically with the vertical slide panel 106 along the rail 105. The container support panel 111 may hold or restrain a container of material (e.g., container 300 as shown in FIG. 3). The container support panel 111 may include one or more platforms 108 that the container of material can rest on or be held in place within. For example, the container (e.g., container 300) may rest on or be held in place within the platform 108 and move vertically as the vertical slide panel 106 moves vertically with respect to the remainder of the chassis 101. For example, the platform 108 may comprise an outer frame configured to receive the container or portion of the container within. For example, the outer frame of the platform may have a generally cylindrical shape with openings along the side walls to permit a sensor to view the container or portion thereof within the platform 108. For example, the platform 108 may include restraints configured to retrain the container (e.g., container 300). For example, the platform 108 may include restraints that prevent the container (e.g., container 300) from falling from the platform 108. For example, the platform 108 may include restraints that grasp the container and prevent most or all movement of the container (e.g., container 300) relative to the platform 108 or vertical slide panel 106. For example, the restraints may be tightened or fastened to restrain the container (e.g., container 300) within or to the platform 108. For example, the restraints may include clasps or clamps for restraining the container (e.g., container 300).

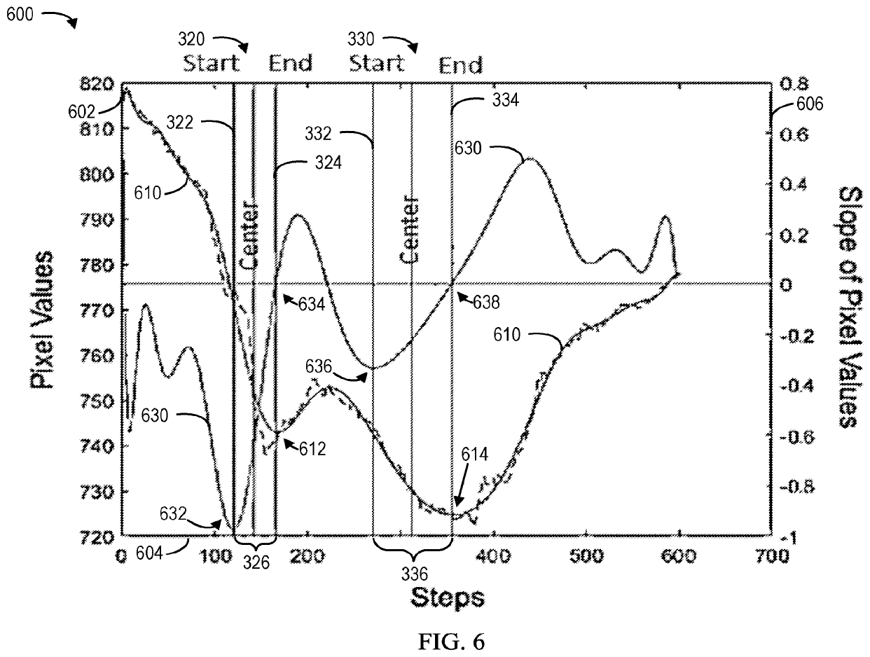

Once the container is in position, the vertical slide panel 106, container support panel 111, platform 108, and motor 104 may be configured to move the container (e.g., container 300) relative a sensor 107. The sensor 107 may be mounted to the chassis 102. For example, the sensor 107 may be coupled directly or indirectly, via a mounting plate, to the upper base plate 103. The sensor 107 may be an optical sensor. For example, the sensor 107 may be configured to sense wavelengths of light refracted from the contents within the container (e.g., container 300) or other electromagnetic waves. For example, the sensor 107 may be a camera. The sensor 107 may include a field of view 109 within which the sensor 107 can sense features of the contents within the container. For example, the sensor 107 may be defined by the area observable by the sensor 107. The field of view 109 may be defined in terms of an angle of reliable observation from a sensory element of the sensor 107. The field of view 109 may be rectangular, ovoid or any other geometric or non-geometric shape. The sensor 107 may be mounted at a fixed position relative to the upper base plate 103. As the container (e.g., container 300) is moved relative to the sensor 107, data may be captured to indicate a location of material within the container. For example, the motor 104, vertical slide panel 106, container support panel 111, and support 108 may be configured to vertically translate the container (e.g., container 300) through the field of view 109 of the sensor 107. As the refracted light observable through the field of view 109 changes, the data captured by the sensor 107 may be indicative of the perceived changes as discussed with respect to FIG. 6.

After locations of the material (e.g., separation points between the different materials) within the container are identified, the motor 104, vertical slide panel 106, container support panel 111, and support 108 may move the container (e.g., container 300) into position for extraction of one of the materials within the container by one or more extraction assemblies 110, 112, 114. The extraction assemblies 110, 112, 114 may be mounted to the chassis 101. For example, the extraction assemblies 110, 112, 114 may be mounted to top side of the upper base plate 103. For example, each extraction assembly 110, 112, 114 may include a planar or substantially planar bottom surface for mounting to the planar top surface of the upper base plate 103. For example, each extraction assembly 110, 112, 114 may be coupled to the upper base plate 103 with bolts, rivets, screws, adhesive, or any other known coupling device. While the example of FIG. 1 shows three extraction assemblies 110, 112, 114, this is for example purposes only as one, two, or any number more than three extraction assemblies may be used in other example embodiments.

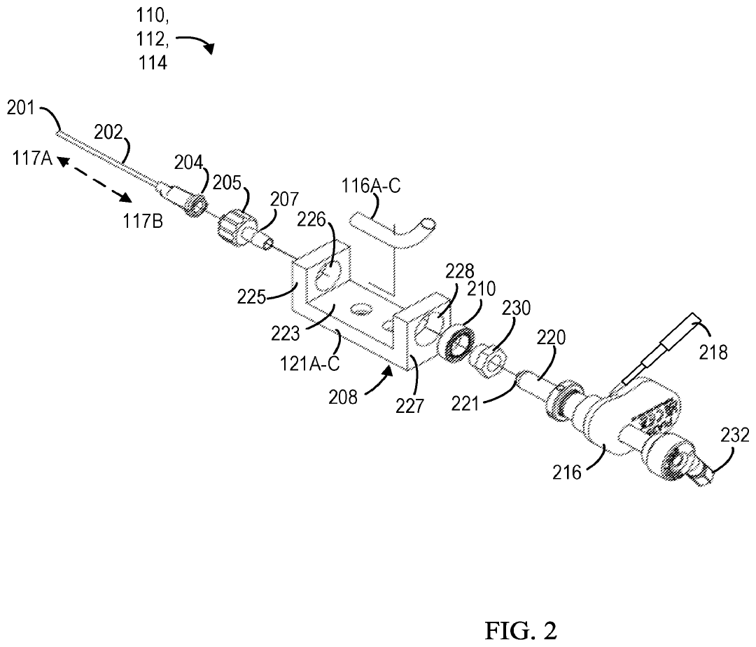

FIG. 2 shows an example extraction assembly 110, 112, 114 according to one example embodiment. Referring to FIGS. 1 and 2, each extraction assembly 110, 112, 114 may include a slide rail member 119A-C. For example, the slide rail member 119A-C may include one or more rails (e.g., bearing rails) and may be coupled to the upper base plate 103. Each extraction assembly 110, 112, 114 may include a needle housing 121A-C. The needle housing 121A-C may be configured to traverse along the corresponding slide rail member 119A-C in the directions of travel 117A-B for the needle housing 121A-C. For example, the bottom side of the needle housing 121A-C may include rail guides 208 or bearing slides for sliding along the corresponding rail or rails of the slide rail member 119A-C. For example, the needle housing 121A-C may be positioned above and ride along a top side of the corresponding slide rail member 119A-C in the directions of travel 117A-B.

More than one extraction assembly (e.g., extraction assemblies 110, 112, 114) may be used to extract material from the container (e.g., container 300). For example, the container (e.g., container 300) may be located in the center of a portion of the chassis 101 and the extraction assemblies (e.g., extraction assemblies 110, 112, 114) may be spaced and directed radially inward toward the container (e.g., container 300). For example, the extraction assemblies 110, 112, 114 may be spaced equidistant from one another along a circumference where the container (e.g., container 300) is located at a center of the circumference. For example, when three extraction assemblies 110, 112, 114 are used, the extraction assemblies may be spaced 120° from one another. In other examples, the extraction assemblies 110, 112, 114 may be spaced at different distances from the container 300, when in position for extraction, and/or may be spaced at different angles from one another along the circumference, wherein the container 300 is located at the center of the circumference.

Each extraction assembly 110, 112, 114 may include a needle housing 121A-C. The needle housing 121A-C may include a base panel 223. The base panel 223 may include a front edge and a distal back edge. The needle housing 121A-C may include a front wall 225 extending up vertically or substantially vertically from the front edge of the base panel. The needle housing 121A-C may include a rear wall 227 extending up vertically or substantially vertically from the back edge of the base panel 223. The front wall 225 may include an aperture 226 extending through the front wall 225 to create a passageway through the front wall 225 parallel to or along the directions of travel 117A-B. The rear wall 227 may include an aperture 228 through the rear wall 227 to create a passageway through the rear wall 227 parallel to or along the directions of travel 117A-B.

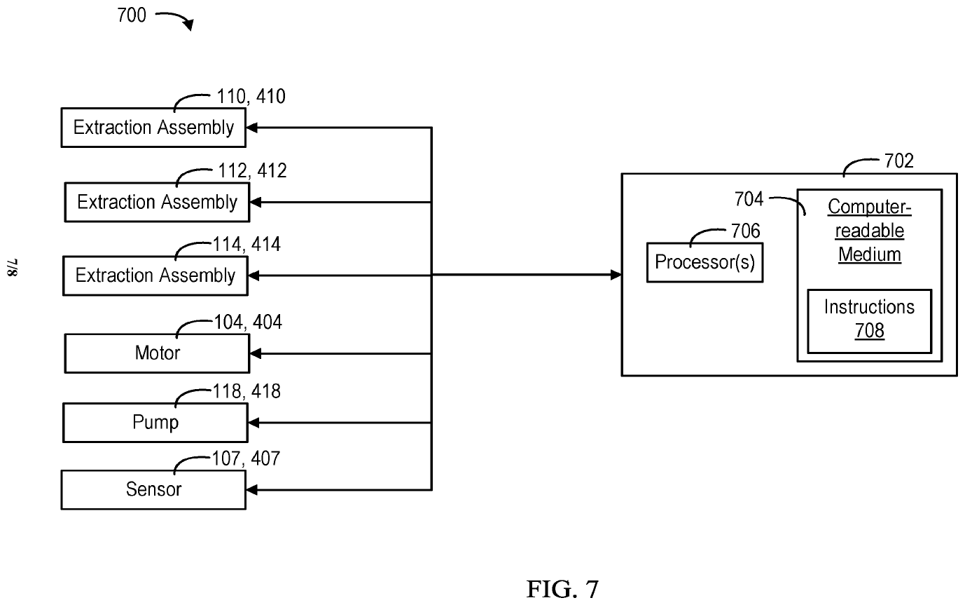

For example, the needle housing 121A-C and the slide rail member 119A-C may be configured to ensure linear and parallel movement of a needle (e.g., needle 202 along the directions of travel 117A-B. For example, each extraction assembly 110, 112, 114 may include a bearing assembly 210. The bearing assembly 210 may be configured to be inserted into the aperture 228 of the rear wall 227 of the needle housing 121A-C. For example, the bearing assembly 210 may reduce angular forces provided by a linear actuator 216. For example, each extraction assembly 110, 112, 114 may include a linear actuator 216. For example, the linear actuator 216 may be coupled directly or indirectly to the needle housing 121A-C. For example, the linear actuator 216 may be configured to move the needle 202 radially inward in the direction of travel 117A toward the container 300. For example, the linear actuator 216 may include a rod 220. The rod 220 may transfer linear and rotational motion to the needle housing 121A-C. The bearing assembly 210 may remove rotational forces imparted by the rod 220 on the needle housing 121A-C to ensure that the only forces applied to the needle 202 are linear, reducing the likelihood of coring the container 300. The rod 220 may be affixed to the bearing assembly 210 with a bearing nut 230. For example, the bearing assembly 210 may be sized to receive an end of the bearing nut 230. For example, the bearing nut 230 may be configured to further receive a flange 221 of the rod 220. In such a way, the bearing nut 230 joins the rod 220 with the needle housing 121A-C through the bearing assembly 210 to remove rotational forces and transfer linear forces caused by the linear actuator 216. The linear actuator 216 may include a socket 218 for receiving commands from and transmitting positional feedback data to a controller, such as the controller 702 of FIG. 7. The linear actuator 216 may include a fluid intake 232. The fluid intake may be configured to receive hydraulic fluid or pneumatic air for adjusting the position of the linear actuator 216.

Each extraction assembly 110, 112, 114 may include a needle 202. The needle 202 may include a fixed end and a distal free end defining a tip 201 of the needle 202. For example, the tip 201 of the needle 202 may be beveled. The fixed end of the needle 202 may be coupled indirectly to the needle housing 121A-C using a needle hub 204 and a fitting 205. For example, the fitting 205 may be a Luer lock type fitting. For example, all or at least a portion of the fitting 205 may extend into the aperture 226 of the front wall 225 of the needle housing 121A-C. The needle housing 121A-C may include another fitting 207. The other fitting 207 may have a first end coupled to the fitting 205 and a distal second end configured for securing an extraction pipe 116A-C to the needle housing 121A-C and allowing for the conveyance of fluid from the container 300, via the needle 202, to a pump 118. The needle housing 121A-C in combination with the slide rail member 119A-C may direct linear movement of the needle 202 along the directions of travel 117A-B. The directions of travel 117A-B may be radially inward towards and outward away from the support 108 and container 300 with respect to the other extraction assemblies. For example, the entire fluid contact path of each extraction assembly 110, 112, 114 may be single use and disposable. For example, the needle 202 and piping 116A-C, 120, 122 may be respectively disconnected and replaced.

As such, insertion of each respective needle (e.g., needle 202) into the container 300 by each corresponding extraction assembly 110, 112, 114 and corresponding linear actuators 216 may be performed at the same time or substantially the same time such that equal pressure is applied by each needle 202 of each extraction assembly 110, 112, 114 to avoid shifting of the container 300 or to prevent an unequal application of force to the container 300.

The system 100 may further include one or more respective pipes or tubes (e.g., extraction pipes 116A-C). The one or more extraction pipes 116A-C may be directly or indirectly connected with a respective needle 202) for extraction of material from the container 300. For example, a pump 118 may be configured to receive one or more inlet pipes 120. The inlet pipe 120 may be fluidically coupled to one or more of the extraction assemblies 110, 112, 114 and configured to receive material extracted by each needle 202 of the corresponding extraction assembly 110, 112, 114 through the corresponding extraction pipe 116A-C. The pump 118 may draw a vacuum on the needle 202. The pump 118 may be primed, along with extraction pipes 116A-C and inlet pipe 120, with an inert liquid to prevent cavitation of the pump 118. An outlet pipe 122 may be attached to the pump 118 to deposit material received from the container 300 via the needles 202 and corresponding extraction pipes 116A-C in a reservoir 124. A controller (e.g., controller 702 of FIG. 7) may be used to operate and receive data from the actuators 216 of each respective extraction assembly 110, 112, 114.

FIG. 3 shows an example container 300 in accordance with one example embodiment of the disclosure. Referring now to FIGS. 1-3, the container 300 may have any shape and size and may be made of polycarbonate, polyethylene, polyallomer, a transparent plastic material, or a combination thereof. The container 300 may be filled with a liquid 302, such as cesium chloride solution, for example 3M cesium chloride, iodixanol, sucrose, sodium bromide, sodium iodide. A material of interest, such as a nucleic acid or viral particle, including, but not limited to, an AAV particle, may be dispersed in the liquid 302 and diffused about the container 300. A centrifuge or ultracentrifuge may be used to stratify the material (e.g., material 320, 330) within the density gradient provided by the solution 302 to separate the desired material from any contaminants and to enable removal of a specific zonal band. During extraction, the container 300 may be vented. For example, a separate needle may puncture the top of the container 300 or a top portion of the container may be removed or left open to the ambient environment. One or more needles 202 may be inserted with a corresponding actuator 216 via one or more of the corresponding extraction assemblies 110, 112, 114. A nipple portion of the container 300 may also be removed. Ultracentrifugation of the container containing the solution (e.g., cesium chloride) and the material of interest stratifies the material into bands such that one or more of the bands contains the material of interest purified away from contaminants having density different from the material of interest. For example, identification of a start (e.g., starts 322, 332 at the bottom of a segregated zonal band with respect to gravity) of the material, visualized as a band, 320, 330 may be determined and an end (e.g., ends 324, 334 at the top of a segregated zonal band with respect to gravity) may be determined, forming ranges 326, 336 representing a band within the container 300.

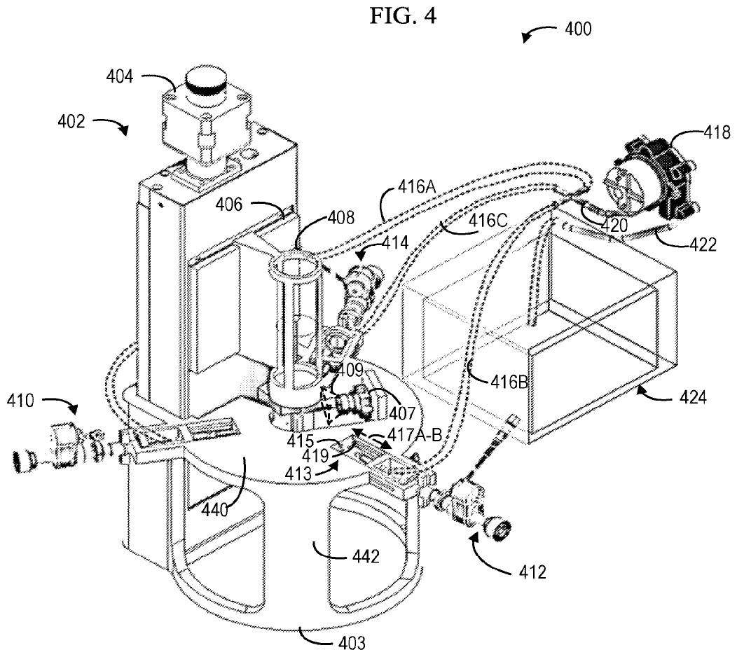

FIG. 4 shows another example system 400 for material extraction according to one example embodiment of the disclosure. Referring now to FIG. 4, the example system 400 may include a chassis 402. The chassis 402 may define planes of translation for components of the system 400 and references for those components. The chassis 402 may include a support platform 403. For example, the support platform 403 may include a top surface 440 configured to receive one or more extraction assemblies 410, 412, 414. The top surface may be planar or substantially planar or flat. The top surface 440 of the support platform 403 may be raised about a ground surface by one or more supports 442.

The chassis 402 may include a vertical slide panel 406. The vertical slide panel 406 may be configured to move vertically about an axis or plane defined by the chassis 402. The vertical slide panel 406 may be actuated by a motor 404. For example, the motor 404 may be a stepper motor or any other type of motor. For example, the motor 404 may include sensory feedback via a sensor (e.g., an optical sensor) to accurately manage the position of the vertical slide panel 406 in particular ranges or steps. In certain examples, the motor 404 may be replaced with another device, such as a hydraulic or pneumatic actuator. Each of the steps may be equivalent over the range of motion of the vertical slide panel 406 and defined according to a metric (e.g., inches, millimeters). For example, each step may be 1 millimeter.

The vertical slide panel 406 may include or be coupled to a support 408. The support 408 may receive, hold, and/or restrain a container of material (e.g., container 300 as shown in FIG. 3). The support 408 may include one or more platforms that the container 300 of material can rest on or be received by. For example, the container 300 may rest on or be attached or restrained to a platform of the support 408 that moves as the vertical slide panel 406 moves vertically with respect to the chassis 402. For example, the support 408 may include restraints configured to retrain the container 300. For example, the support 408 may include restraints that prevent the container 300 from falling from the platform or moving with respect to the support 408. The support 408 may include restraints that grasp the container 300 and prevent most or all movement of the container 300 relative to the platform, support 408, and/or vertical slide panel 406. For example, the restraints may be tightened or fastened to restrain the container 300. For example, the restraints may include clasps or clamps for restraining the container 300.

Once the container 300 is in position within the support 408, the vertical slide panel 406, support 408, and motor 404 may be configured to move the container 300 relative to a sensor 407 and/or the top surface 440. For example, the sensor 407 may be mounted to the chassis 402. For example, the sensor 407 may be mounted to the top surface 440 of the support platform 403. For example, the sensor 407 may be an optical sensor. For example, the sensor 407 may be configured to sense wavelengths of light refracted from the material within the container 300 or other electromagnetic waves. For example, the sensor 407 may be a camera. The sensor 407 may include or be able to detect objects and material within a field of view 407. For example, the sensor 407 may be defined by the area (e.g., field of view 409) observable by the sensor 407. The field of view 409 may be defined in terms of an angle of reliable observation from a sensory element of the sensor 407. The field of view 409 may be rectangular, ovoid, or any other geometric or non-geometric shape. For example, the sensor 407 may be mounted at a fixed position relative to the chassis 402. As the container 300 is moved (e.g., via the support 408 and vertical slide panel 406) relative to the sensor 407, data may be captured to indicate a location of material within the container 300. For example, the motor 404, vertical slide panel 406, and support 408 may be configured to vertically translate the container 300 through the field of view 409 of the sensor 407. As the refracted light observable through the field of view 409 changes, the data captured may be indicative of the perceived changes as discussed with respect to FIG. 6.

After locations of the material within the container 300 are identified, the motor 404, vertical slide panel 406, and support 408 may move the container 300 into position for extraction by one or more extraction assemblies 410, 412, 414. The extraction assemblies 410, 412, 414 may be mounted to the chassis 402. For example, the top surface 440 of the platform 403 of the chassis 402 may include one or more receptacles 413 or cut-outs. Each of the one or more receptacles 413 or cut-outs may be sized to receive a housing 506 of a corresponding extraction assembly 410, 412, 414. For example, the housing 506 may have a planar portion configured to ensure the linear and parallel movement of a needle (e.g., needle 502) along a direction of travel 417. For example, each extraction assembly 410, 412, 414 may include a linear actuator 516 to move the needle 502 inward (e.g., radially inward) toward and outward away from the container 300. The chassis 402, such as the top surface 440 of the platform 403 may define a hole or aperture 415 to ensure the needle 502) is unimpeded.

More than one extraction assembly, such as extraction assemblies 410, 412, 414, may be used to extract material from the container 300. For example, the container 300 may be located in the center of a portion of the chassis 402 and/or the top surface 440 and the extraction assemblies 410, 412, 414 may be spaced apart from one-another and directed radially inward toward the container 300. For example, the extraction assemblies 410, 412, 414 may be spaced equidistant from one another along a circumference where the container 300 is located at a center of the circumference. For example, when three extraction assemblies 410, 412, 414 are used, the extraction assemblies 410, 412, 414 may be spaced apart 120 degrees from one another. As such, insertion of each respective needle 502 into the container 300 may occur at the same time or substantially the same time, such that equal pressure is applied by each needle 502 on the container 300 to avoid shifting of the container 300 or applying an unequal force to the container 300. In other examples, the extraction assemblies 410, 412, 414 may be positioned at different distances from the container 300 and/or at different distances from one another, such that they are not equidistant. While the example of FIG. 4 shows three extraction assemblies 410, 412, 414, this is for example purposes only. In other example embodiments, the number of extraction assemblies may be one, two, or any number greater than three extraction assemblies.

One or more pipes or tubes (e.g., extraction pipes 416A-C) may be directly or indirectly connected with one or more needles 502 of each corresponding extraction assembly 410, 412, 414 for extraction of material from the container 300. For example, a pump 418 may be configured to receive one or more inlet pipes 420. The inlet pipe 420 may be fluidically coupled to one or more of the extraction assemblies 410, 412, 414 and configured to receive material extracted by the needle 502 of each corresponding extraction assembly 410, 412, 414 via the corresponding extraction pipe 416A-C. The pump 418 may draw a vacuum on each corresponding needle 502. For example, the pump 418 may be primed, along with extraction pipes 416A-C and inlet pipe 420, with an inert liquid to prevent cavitation of pump 418. An outlet pipe 422 may be attached to pump 418 to deposit material in a reservoir 424. A controller (e.g., controller 702 of FIG. 7) may be used to operate and receive data from the corresponding actuators 216 of respective extraction assembly 410, 412, 414).

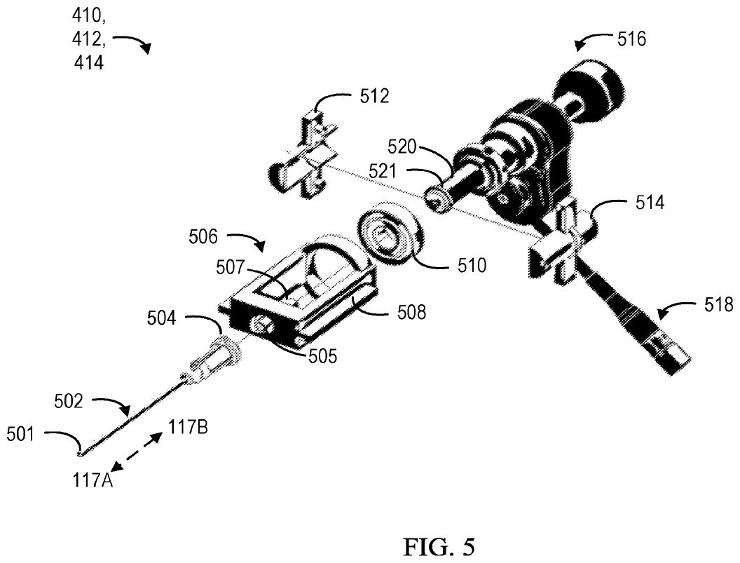

FIG. 5, shows another example extraction assembly 410, 412, 414 in accordance with one example embodiment of the disclosure. The extraction assembly 410, 412, 414 may include a needle 502. The needle 502 may include a fixed end and a distal free end. The free end of the needle 502 may include a tip 501 of the needle 502. For example, the tip 501 of the needle 502 may be beveled. The fixed end of the needle 502 may be fixed to a housing 506 using a needle hub 504 and a fitting 505. For example, the fitting 505 may be a Luer lock type fitting. The housing 506 may include another fitting 507 for securing the corresponding extraction pipes 416A-C to the housing 506 and allowing for the conveyance of fluid from the needle 506 to the pump 416 via the corresponding extraction pipes 416A-C. The housing 506 may include a rail 508. The rail 508 may be sized to slide within the receptacle 413 along a track 419. The rail 508, in combination with the track 419, may direct linear movement of the housing 506 and thus the needle 502 along the directions of travel 417A-B. The directions of travel 417A-B may be radially inward and outward with respect to the other extraction assemblies toward the support 408 and the container 300. For example, the entire fluid contact path of the extraction assembly 410, 412, 414 may be single use and disposable. For example, the needle 502 and piping 416A-C, 420, 422 may be respectively disconnected and replaced.

The housing 506 may define an opening sized to receive a bearing assembly 510. The bearing assembly 510 may reduce angular forces provided by the linear actuator 516. For example, the linear actuator 516 may include a rod 520. The rod 520 may transfer linear and rotational motion to the housing 506. The bearing assembly 510 may remove rotational forces imparted by the rod 520 on the housing 506 to ensure that the only forces applied to the needle 502 are linear, reducing the likelihood of coring the container 300. The rod 520 may be affixed to the bearing assembly 510 with an adapter. For example, the adapter may include a first portion 512 and a second portion 514. For example, the bearing assembly 510 may be sized to receive an end of the first portion 512 of the adapter and an end of the second portion 514 of the adapter, and the first portion 512 and the second portion 514 of the adapter may join to receive a flange 521 of the rod 520. For example, the adapter joins the rod 520 with the housing 506 through the bearing assembly 510 to remove rotational forces and transfer linear forces caused by the linear actuator 516. For example, the linear actuator 516 may include a socket 518 for receiving commands from and sending data to a controller, such as the controller 702 of FIG. 7.

FIG. 6 shows example values 602 (e.g., pixel values) in accordance with one example embodiment of the present disclosure. The example values 602 are presented to form a plot 600. The values 602 may be pixel values or another type of value (e.g., data) provided by the sensor 107, 407 or another device. For example, the values 602 may be luminance averages of pixels received in the field of view 109, 409. For example, a light may be shown on or through the container 300 to emphasize the differences between materials in the solution 302. The values 602 may be a subset of the pixels available from the field of view 109, 409. For example, the values 602 may be from a quantity of rows of pixels from the field of view 109, 409. The values 602 may be associated with a particular step (e.g., step 604) or location of the container 300 based on the motor 104, 404 or another actuator position. A step may be based on an encoder (e.g., an optical encoder) associated with the motor 104, 404. The values 602 and the related step 604 may be used to provide a scatterplot of the values 602 against steps 604.

A regression may be performed on the data to determine a regression line 610 based on the values 602 and the steps 604. For example, the regression line may be a polynomial. A derivative of the polynomial (e.g., the regression line 610) may be taken to determine the derivative 630 of the regression line 610 with slope values 606. The derivative 630 may be used to determine the minimums 612, 614 of the regression line 610 (at zeros 634, 638 of the derivative 630), and a second derivative (not shown) may be used to determine the minimums 632, 636 of the derivative 630. The start 322 of a span or range 326 for the material 320 may be determined based on the regression line of the values 602 and the minimum 632 at a little more than 100 steps (as shown). The end 324 of the span or range 326 for the material 320 may be determined based on the regression line of values 602 at a little less than 200 steps (as shown). The start 332 of a span or range 336 for the material 330 may be determined based on the regression line of the values 602 and the minimum 636 at a little less than 300 steps (as shown). The end 334 of the span or range 336 for the material 330 may be determined based on the regression line of values 602 between 300 and 400 steps (as shown). The values 602 may be adjusted to a zero position of the container 300 or motor 104 may zero the container 300 to ensure that the values and the steps are relative to one another. An offset may be used to adjust the zero position. An offset may also be used to indicate the needle insertion point (e.g., the tip 201, 501 inserts into the container 300 at 45 steps from the zero position).

Once derivative 630 and the second derivative are determined, the zeros (e.g., zeros 634, 638) of the derivative 630 may be used to determine ends 324, 334. With the step location of the ends 324, 334 determined based on the zeros 634, 638, the zeros of the second derivative may be used to determine starts 322, 332 and minimums of derivative 630. For example, zero 634 may be located at about step 166 as shown. The zero of the second derivative immediately preceding zero 634 may be found at about step 120 as shown (e.g., scan until zero is found for the second derivative less than the zero for the first derivative). For example, the derivative 630 of regression line 610 may be used to determine zero 634 and the end 324 and the second derivative of regression line 610 (not shown) may be used to, with the immediately preceding second derivative zero shown as minimum 632, determine the start 322. As such, the ranges 326, 336 may be determined along with the quantity of bands (e.g., two as shown in FIG. 6) associated with the container 300. For example, the quantity of bands may be determined and the container 300 may be rejected or withdrawn if the quantity of bands does not satisfy a predetermined threshold. For example, the quantity of bands determined within the container 300 may be required to satisfy (e.g. be greater than or greater than or equal to) a threshold number of bands (e.g., three bands are required or the container 300 is rejected). As another example, satisfying the threshold may require greater than or less than a certain quantity of bands of material in the container 300 for material extraction. For example, the threshold number of bands may be two and the quantity of bands within the container 300 must be greater than two in order for material extraction to occur.

FIG. 7 shows an example system 700 for a computing system 702 of the material extraction system 100, 400 in accordance with one example embodiment of the disclosure. For example, the computing system 702 may comprise a controller 702. For example, the controller 702 may include one or more processors 706 in communication with a computer-readable medium 704. The computer-readable medium 704 may include one or more computer-executable instructions 708. The computer-executable instructions 708 may be stored in the form of an executable that is executable by the one or more processor 706. The computer-executable instructions 708 may be in the form of or defined as machine code, assembly code, or high-order languages (e.g., C, Python). The computer-executable instructions 708 may be executed by the one or more processors 706 to perform one or more operations or steps described herein. For example, the computer-executable instructions 708 may include logic for controlling one or more extraction assemblies 110, 112, 114, 410, 412, 414, such as instructions for operating a linear actuator 216, 516, or receiving feedback from one or more extraction assemblies 110, 112, 114, 410, 412, 414. The computer-executable instructions 708 may further include logic for receiving data from one or more sensors 107, 407, operating the pump 118, 418, or operating the motor 104, 404. The computer-executable instructions 708 may include operations for receiving data from the sensor 107, 407. For example, the received data may be received as a digital or analog signal. The controller 702 may include an analog-to-digital converter for processing analog sensor data. The computer-executable instructions 708 may include operations for determining a position of the material and/or the container 300. The computer-executable instructions 708 may include operations for actuation of one or more actuators 216, 516. The computer-executable instructions 708 may include instructions for operating the pump 118, 418, including control of an adjustable flow rate of the pump 118, 418. It should be appreciated that each actuator 216, 516 may be controlled by an independent controller (e.g., a programmable-logic controller) that receives positional commands or voltage-based commands from the controller 702.

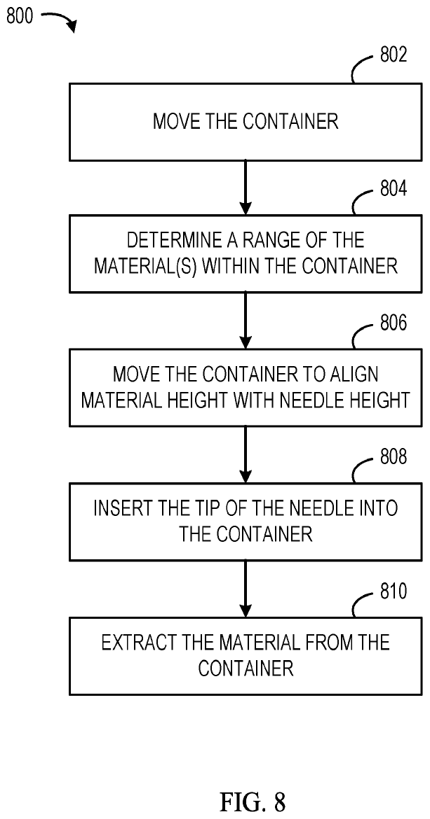

FIG. 8 shows a flowchart of an example method 800 for material extraction according to one example embodiment of the disclosure. Referring now to FIGS. 1-8, the method 800 may be performed by one or more of the devices disclosed herein, including, but not limited to, the extraction assemblies 110, 112, 114, 410, 412, 414, the motor 104, 404, the linear actuator 216, 516, the sensor 107, 407, the needle 202, 502, the pump 118, 418, and/or the controller 702. At 802, a container may be moved. For example, the container may comprise the container 300. For example, the container 300 may comprise material 320, 330. For example, the container 300 may be moved about or vertically through a field of view 109, 409 of a sensor 107, 407. For example, the container 300 may be placed on, coupled to, or restrained by the support 108, 408. For example, the container 300 may be vented automatically or manually using a needle or by preparing a hole at the top or along another portion of the container 300 with respect to gravity. For example, the support 108, 408 may translate, move, or step vertically or substantially vertically through available locations (e.g., steps 604) as the sensor 107, 407 evaluates the material 320, 330 within the container. For example, the sensor 107, 407 may generate data (e.g., values 602) based on signals from the sensor 107, 407 and associated with the steps 604 to form a plot 600.

At 804, a range of the material(s) within the container 300 may be determined. For example, the range of the material(s) may be similar to the ranges 326, 336 discussed in FIG. 3. For example, the range of the material(s) may be determined by the computing device 702, such as a controller 702. For example, the range of material(s) may be determined based on the motor 104, 404 moving the container 300 vertically past the sensor 107, 407. For example, the location of material within the container 300, such as material 320, 330, may be determined over a range of steps 604 initiated by the motor 104, 404 when moving the container 300 vertically past the sensor 107, 407.

At 806, the container 300 may be moved, with the material therein, to substantially align the material (e.g., one or more of material 320, 330) with at least one needle 202, 502 of at least one extraction assembly 110, 112, 114, 410, 412, 414. For example, the container 300 may be moved into the aligned position by the computing device 702, such as the controller 702. For example, the container 300 may be moved vertically into position by the motor 104, 404 moving, based on a signal from the controller 702, the vertical slide panel 106, 406 and corresponding planform 108, 408 carrying the container 300 vertically (up or down) until the level of at least a portion of the desired material is at the level of at least one of the needles 202, 502. For example, the location (e.g., vertical level) of the needle 202, 502 with respect to the steps taken by the motor 104, 404 may be known by the controller 702 such that the needle 202, 502 is predicted to puncture the container 300 at the level of the desired material at a known quantity of steps. For example, the motor 104, 404 may be adjusted such that the predetermined direction of travel (e.g., the direction of travel 117A or (optionally radially) inward toward the container 300) will intersect with the location of the desired material in the container 300, thereby allowing for extraction of the desired material with the needle 202, 502. For example, the needle 202, 502 may be known to begin intersecting with the container 300 at 100 steps (e.g., 100 steps of vertical downward motion by the motor 104, 404 when at least a portion of the container 300 is held in the platform 108, 408. After determining the position of the material 320 within the container 300, the motor 104, 404 may adjust the vertical positioning of the support 108, 408 to move the material 320 to 100 steps for intersection with the needle 202, 502 when the needle 202, 502 is moved in the direction of motion 117A, 417A by the linear actuator 216, 516 and inserted into the container 300. For example, a predetermined offset may be used (e.g., one or two of the steps 404 or any other amount between 1-50 steps) to ensure the needle 202, 502 is inserted just within or outside (e.g., below) the expected location of the material 320 (e.g., just below the predicted start 322 of the material 320) within the container 300. In such a way, the material 320 may be substantially aligned (e.g., a predetermined percentage, distance, or threshold within the expected start 322 of the range 326 or below the expected start 322 of the range 326) for the desired material. By inserting the needle 202 substantially near the start 322 of the range 326, more of the material 320 may be extracted.

At 808, the tip 201, 501 of the needle 202, 502 may be inserted through the side wall of the container 300 and into an interior of the container. For example, the tip 201, 501 may be inserted based on one or more signals from the computing device 702, such as the controller 702. For example, the linear actuator 216, 516 may move or drive the tip 201, 501 in the direction of travel 117A, 417A and through the wall of the container 300 to extract the desired material 320 inside the container 300. For example, the linear actuator 216, 516 may move the needle 202, 502 and tip 201, 501 based on one or more instructions received from the controller 702. In addition, a speed of travel of the tip 201, 501 may be determined along the predetermined direction of travel 117A, 417A. For example, the speed of travel may be determined by the controller 702. For example, the speed of travel of the tip 201, 501 may be mapped to the flow rate of the pump 118, 418 to ensure that removal of material 320 begins when the tip 201, 501 is initially inserted through the wall of the container 300 and into the interior of the container 300 and is complete when the tip 201, 501 reaches maximum extension or target depth of the insertion. For example, the maximum extension or target depth of insertion may be 75% of the distance between the outer periphery of the container 300 and the center of the container 300. In other example, other target depths may be used, such as target depths between 25%-100% of the distance. For example, a quantity of material 320 may be determined and the expected flow rate of the pump 118, 418 over the expected period of tip insertion within the container 300 may be determined. For example, the determinations may be made by the controller 702. For example, the quantity of material may be based on the range 326, the length of cylinder associated with the range based on the length of each step 604, and the radius of the container 300 (e.g., the volume of a cylinder). For example, the quantity of material may be divided by the quantity of extraction assemblies (e.g., one third for each of the three example extraction assemblies 110, 112, 114, 410, 412, 414) along with the expected flow rate of the pump 118, 418. As such, the speed (e.g., cm/s) of the tip 201, 501 as it is being moved towards and inserted into the container 300 may be determined to ensure that the proportioned quantity of material is extracted by the time the tip 201, 501 reaches desired maximum extension. For example, the controller 702 may operate the linear actuator 216, 516 to ensure the speed is met and maintained. For example, an electric machine associated with the linear actuator 216, 516 may be energized to translate the rod 220, 520 in the direction of travel 117A, 417A. The tip 201, 501 may be directly or indirectly moved by the rod 220, 520.

At 610, the desired material may be extracted. For example, the desired material may be extracted by operation of the pump 118 such that the material 320 moved through the tip 201, 510, the needle 202, 502, one or more of the extraction pipes 116A-C, 416A-C, the inlet pipe 120, 420, and the outlet pipe 122, 422 and is deposited into the reservoir 124, 424.

Before the material (e.g., the material 320) is located and extracted, a centrifuge may rotate the container 300 to cause a density gradient in the container. The density gradient may include the material 320. The range (e.g., the range 326, 336) may be determined based on a regression line (e.g., the regression line 610) and a derivative (e.g., the derivative 630) of the regression line. It may be known that the density of material 320 is higher, or lower, than the density of material 330. As such, an interface or selection may be made to ensure extraction of one range, or span, (e.g., the range 326) is chosen for extraction over the other range(s), or span(s), (e.g., the range 336). For example, the desired material may be predetermined by an assaying of bands harvested from a reference gradient. The controller 702 may further include instructions 708 for moving the container 300 to a first vertical position for extraction of the material 320 and after extraction of the material 320 to another vertical position for extraction of the material 330. The tip 201, 501 may be reinserted for extraction of the second material 330. The extraction pipes 116A-C, 416A-C, inlet pipe 120, 420, and outlet pipe 122, 422 may be individually or collectively monitored by another sensor to ensure that the extracted material (e.g., material 320) is the desired material and not solvent 302. For example, the additional sensor may use electromagnetic waves (e.g., ultrasonic, visible light, infrared light) to monitor the material conveyed within the extraction pipe 116A-C, 416A-C, inlet pipe 120, 420, and outlet pipe 122, 422. For example, if the material is not desired, the pump 118, 418 may be deenergized or the material may be discarded. The method 800 may further include retracting the needle 202, 502 in the direction of travel 117B, 417B using the linear actuator 216, 516 based on instructions from, for example, the controller 702 after some or all of the material is extracted.

The method steps recited throughout this disclosure may be combined, omitted, rearranged, or otherwise reorganized with any of the figures presented herein and are not intended to be limited to the four corners of each sheet presented.

The techniques disclosed herein may be implemented on a computing device in a way that improves the efficiency of its operation. As an example, the methods, instructions, and steps disclosed herein may improve the functioning of a computing device.

While the methods and systems have been described in connection with specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A system comprising:
a base plate comprising a sensor having a field of view;
a support configured to receive a container comprising a density gradient with material stratified into a band;
a first actuator configured to move the support and the container with respect to the field of view and with respect to the base plate; and
an extraction assembly coupled to the base plate and comprising a needle, wherein the needle moves with respect to the base plate and engages the container.

2. The system of claim 1, further comprising a second actuator coupled to the extraction assembly and configured to move the needle with respect to the base plate.

3. The system of claim 1, wherein the extraction assembly comprises:
a slide rail member coupled to the base plate; and
a needle housing comprising the needle, wherein the needle housing moves with respect to the slide rail member and the base plate.

4. The system of claim 1, wherein the support further comprises a coupling device for holding the container in place within the support.

5. The system of claim 1, further comprising:
a pump;
an inlet pipe fluidically coupled to the extraction assembly and configured to convey the material from the extraction assembly to the pump; and
an outlet pipe configured to convey the material from the pump to a reservoir.

6. The system of claim 1, wherein the first actuator is configured to move the support in a vertical direction and the needle is configured to move in a horizontal direction.

7. The system of claim 1, further comprising:
a second extraction assembly coupled to the base plate and comprising a second needle, wherein the second needle moves with respect to the base plate and engages the container; and
a third extraction assembly coupled to the base plate and comprising a third needle, wherein the third needle moves with respect to the base plate and engages the container.

8. (canceled)

9. (canceled)

10. An apparatus comprising:
a slide rail member;
a needle housing disposed above the slide rail member and configured to move along the slide rail member; and
a needle coupled to the needle housing.

11. (canceled)

12. The apparatus of claim 10, further comprising a first fitting configured to fluidically couple the needle to a pipe.

13. The apparatus of claim 10, further comprising an actuator coupled to the needle housing and configured to move the needle housing along the slide rail member.

14. (canceled)

15. (canceled)

16. (canceled)

17. A method comprising:
moving a container comprising material about a field of view of a sensor;
determining, based on the sensor, a range indicative of a portion of the material;
moving, based on the range, the material;
moving a needle in a direction of travel to insert a tip of the needle through the container; and
extracting the portion of the material.

18. (canceled)

19. The method of claim 17, wherein the insertion of the tip into the container is based on the direction of travel.

20. The method of claim 17, further comprising pumping the portion of the material to a reservoir.

21. The method of claim 17, further comprising rotating the container to cause a density gradient in the container, wherein the density gradient includes the portion of the material.

22. The method of claim 17, wherein inserting the tip further comprises energizing an electric machine to translate a rod of a linear actuator, wherein inserting the tip is based on the translation of the rod.

23. The method of claim 17, wherein determining the range further comprises determining a regression line, wherein the regression line is based on at least one value from the sensor and at least one position of the container captured during the movement of the container about the field of view of the sensor.

24. The method of claim 23, wherein determining the range further comprises determining a derivative of the regression line.

25. The method of claim 24, wherein determining the range further comprises determining a minimum of the derivative of the regression line and a zero of the derivative of the regression line, wherein a start of the range is based on the minimum and an end of the range is based on the zero of the derivative of the regression line.

26. (canceled)

27. The method of claim 24, wherein determining the range further comprises:
determining a first minimum of the derivative of the regression line and a first zero of the derivative of the regression line, wherein a start of a first span is based on the first minimum and an end of the first span is based on the first zero of the derivative of the regression line; and
determining a second minimum of the derivative of the regression line and a second zero of the derivative of the regression line, wherein a start of a second span is based on the second minimum and an end of the second span is based on the second zero of the derivative of the regression line.

28. (canceled)

29. (canceled)

30. The method of claim 17, wherein extracting the material further comprises:
determining a quantity of the portion of the material, wherein the quantity of the portion of the material is based on one or more of the range, a dimension of the container, or a length of a step; and
energizing, based on the one or more of the quantity of the portion of the material or a flow rate of a pump, the pump connected with the needle to convey the portion of the material.

31. (canceled)
